(19) United States
(12) Patent Application Publication
(10) Pub. No.: US 2024/0329614 A1
(43) Pub. Date: Oct. 3, 2024

(54) Smart Plant Management System

(71) Applicant: Aaron W. Klaser, Leander, TX (US)

(72) Inventor: Aaron W. Klaser, Leander, TX (US)

(21) Appl. No.: 18/126,929

(22) Filed: Mar. 27, 2023

(51) Int. Cl. G05B 19/042

(52) U.S. Cl. CPC G05B 19/042; G05B 2219/2625

(57) ABSTRACT

A Smart Plant Management System (SPMS) is disclosed. The SPMS is a technology ecosystem that raises plants autonomously and without the need for human intervention. Computer systems monitor each plant's health independently and in real-time to control environmental inputs based on Artificial Intelligence (AI) algorithms. Said algorithms learn specific plant needs based on soil conditions and growth trends over time and dynamically changes management strategies ‘on the fly.’ This AI, (combined with block chain tracking technology), predicts and adjusts inputs needed for each individual plant at any given time in the growth cycle to maintain proper health and successful yields. A main computer system governs all inputs (water, light intensity etc.) and outputs (CO2 venting etc.). Other elements of the SPMS will be discussed in greater detail in this specification below.

### CROSS-REFERENCE TO RELATED APPLICATIONS

The present application includes subject matter disclosed in and claims priority to a provisional application entitled “Smart Plant Management System” filed on Mar. 16, 2023, and assigned Application No. 63/452,514 describing an invention made by the present inventor.

### FIELD OF THE INVENTION

The present invention generally relates to plants. More specifically, it relates to a smart plant management system.

### BACKGROUND

The concept of a smart greenhouse is relatively new and has only been developed in recent years as a response to the increasing demand for more sustainable and environmentally friendly agricultural practices. A smart greenhouse is a highly automated and intelligent greenhouse that uses sensors and other advanced technologies to optimize the growing conditions for plants and increase the efficiency of the greenhouse operation. The earliest forms of greenhouses date back to ancient Rome, where the wealthy used to build structures made of mica or transparent stone to grow exotic plants. However, the modern concept of smart greenhouses began to take shape in the 20th century, with the development of advanced technologies such as computers, sensors, and automation. One of the earliest examples of a smart greenhouse was built in the Netherlands in the 1990s. This greenhouse used sensors to monitor temperature, humidity, and light levels, and used this data to adjust the climate inside the greenhouse to create ideal growing conditions for the plants. Since then, the technology has continued to advance, with new sensors and automation systems being developed that can monitor and adjust a wide range of environmental factors, including CO2 levels, nutrient levels, and water usage.

Artificial intelligence has been increasing rapidly over the last five years and it is important to understand how it evolved and its utility for agriculture. During the early 1950s, Alan Turing (a young British mathematician) was one of the first researchers to explore the mathematical possibility of artificial intelligence. Turing suggested that humans use available information as well as reason in order to solve problems and make decisions and wondered why computers could not do the same. Research was slow. During this time, computers lacked a key prerequisite for intelligence: they couldn't store commands—they could only execute them. In addition, the cost of leasing a computer to conduct such research cost ˜$200,000 a month and only prestigious universities and big technology companies could afford them. Five years later, a logic program was designed to mimic the problem-solving skills of humans and was funded by the RAND Corporation. This program is considered by many to be the first artificial intelligence program and was presented at the Dartmouth Summer Research Project on Artificial Intelligence. In the 1970s computers could store more information and became faster, cheaper, and more accessible. Machine learning algorithms also improved and people got better at knowing which algorithm to apply to specific problems. However, weaknesses continued. The biggest problem was the lack of computational power to do anything substantial: computers simply couldn't store enough information or process it fast enough. In order to communicate, for example, one needs to know the meanings of many words and understand them in many combinations and the computing power was not ready.

In the 1980's, interest in AI was reignited by two sources: an expansion of the algorithmic toolkit, and a boost in private funding. During these years, researchers popularized ‘deep learning’ techniques which allowed computers to learn using experience data. ‘Expert systems which mimicked the decision-making process of a human expert also emerged. This program would ask an expert in a field how to respond in a given situation, and once this was learned for virtually every situation, non-experts could receive advice from that program. Expert systems were widely used in industries. In 1997, reigning world chess champion and grand master Gary Kasparov was defeated by IBM's Deep Blue, a chess playing computer program. This highly publicized match was the first time a reigning world chess champion loss to a computer and served as a huge step towards an artificially intelligent decision-making program. In the same year, speech recognition software, developed by Dragon Systems, was implemented on Windows computers. This was another great step forward in the direction of the spoken language interpretation endeavor. Kismet, a robot developed by Cynthia Breazeal was an AI system that recognized and displayed human emotions.

2015 was considered to be a landmark year for artificial intelligence as the number of software projects as ‘AI Google’ and ‘neural networks’ became available. These increases in affordable neural networks were due to a rise in cloud computing infrastructure and to an increase in research tools and datasets. Other examples of popular AI include Microsoft's development of a Skype system that automatically translates from one language to another and Facebook's system that can describe images to blind people. Around 2016, China greatly accelerated its government funding (given its large supply of data and its rapidly increasing research output) some observers believe it may be on track to becoming an ‘AI superpower.’

Today, some growers have turned to AI to facilitate plant management. Some smart greenhouses are being used around the world to grow a wide variety of crops, from vegetables and fruits to flowers and herbs. They offer numerous benefits over traditional greenhouses, including increased efficiency, reduced energy usage, and improved crop yields. As the technology continues to evolve, it is likely that smart greenhouses will become an increasingly important part of sustainable agriculture in the future. Some in the agricultural industry have begun developing such management systems with artificial intelligence. U.S. Pat. No. 10,803,312B2 granted to Nicholas R. Genty and John M. J. Dominic disclosed a smart greenhouse with artificial intelligence to control inputs. Chinese Patent Nos. CN114778774 (A), CN216820923 (U), CN216018064 (U), CN114080936 (A), CN113849542 (A) granted to Li Haowei, Kang Ruiling, Zhang Wanhe, Zhang, and Feng Lei respectively also disclosed agricultural management systems that are autonomously by means of artificial intelligence. However, what is needed is a smart plant management system that leverages artificial intelligence in conjunction with block chain technology to monitor, maintain and track individual plant history in real time.

### SUMMARY OF THE INVENTION

The device herein disclosed and described provides a solution to the shortcomings in the prior art through the disclosure of a SPMS. An object of the SPMS is to manage plant growth independent of any human interaction. The system operates autonomously and supplies plants with all required inputs and outputs automatically. For example, the SPMS can grow corn and monitor each stock and increase or decrease inputs automatically as needed for each individual plant.

An object of the invention is to provide a means to predict plant needs based on AI algorithms. For example, if a particular plant has become weak, the SPMS's cameras detect slight variations in leaf color and feed this data to the external microprocessor. The software analyzes the images and characterizes the plant's health. The system then reviews data files and predicts how much nutrients will be needed to enhance and continue growth. Results of these actions are then recorded and fed back into the SPMS as a means of continuous machine learning for future predictions.

Another object of the invention is to provide a means to track the history of each plant individually. The SPMS allocates each plant a place on the blockchain that records all inputs and allows stakeholders to view plant status and history in real time. For example, a grower wants to understand how much water a particular plant received over a select few days-they examine the decentralized ledger using their phone or tablet and view exact water amounts given to the plant by the system. Information can also be show graphically in the form of charts for each plant or for groupings of plants.

Another object of the invention is to provide a means to monitor the health of each plant individually. The SPMS monitors all plants using specialized cameras that recognize any discoloration that may contribute to plant stress over time. In addition, the cameras monitor the height of each plant to ensure that proper growth is taking place. Based on the images, the SPMS algorithms have the ability to predict plant yields dynamically.

Another object of the invention is to provide a means to deliver proper light, water, nutrients, herbicides and insecticides to each plant individually. Delivery lines for each plant have electronic metering controls and valves that are managed by the SPMS independently. For example, if the cameras detect slow growth for a particular plant, valve actuators on water and nutrient lines are opened slightly for a plant by the system to allow for greater growth. Individual grow lights above each plant control the amount of light each plant receives and can also be varied. In addition, if any insects are detected by the cameras, the system can target each plant individually with insecticide to minimize plant damage and minimize chemical use and unwanted over-spray.

Another object of the invention is to automatically control environmental conditions for plants in various zones or plant groupings. The SPSMS includes sensors such as temperature, humidity and CO2 that allow the system to control heaters, humidifiers and roof vents independently in each area to maintain optimal growth conditions. For example, one area of a greenhouse continually floods and raises humidity in that location. The SPMS can activate dehumidifiers in a zone of the greenhouse to minimize fungal growth that may damage plants.

Another object of the invention is to share historical activity for each plant and send the information to the SPMS's database. Once the information is stored it is made available to the AI algorithms that continuously learn plant behavior. As more plant data is recorded, the precision of and predictability of the AI increases. In addition, the SPMS allows growers to share this data with other grower operations to further enhance plant management.

Another object of the invention is to alert stakeholders of plant problems in real time. The SPMS has customizable thresholds (such as leaf color, plant height, soil moisture, humidity, temperature etc.) preset by a user. As data is streamed to the block chain any threshold breaches automatically triggers notifications to all stakeholders on the chain. For example, several greenhouses experience a loss of water. The SPMS immediately notifies managers and growers of the abnormality via text messages so that corrective action can take place quickly.

Another object of the invention is to allow for automatic AI analysis on a large number of plants with custom algorithms. Users have the ability to select individual plants, plant groupings and even entire inventories of plants in multiple facilities where the AI tests different variables on a large samples of plants to determine which inputs and outputs automatically yield the best results. This feature allows growers to test alternative management processes in order to determine what strategy is best and obtain verifiable proof said strategy locks in on the optimum automation processes for that particular plant species or grower.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting. As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a front view of the SPMS.

FIG. 2 shows a perspective, closeup view of the camera sensor unit.

FIG. 3 shows the process operations of the SPMS.

FIG. 4 shows a representative view of the block chain.

FIG. 5 shows a representative view of the SPMS method.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

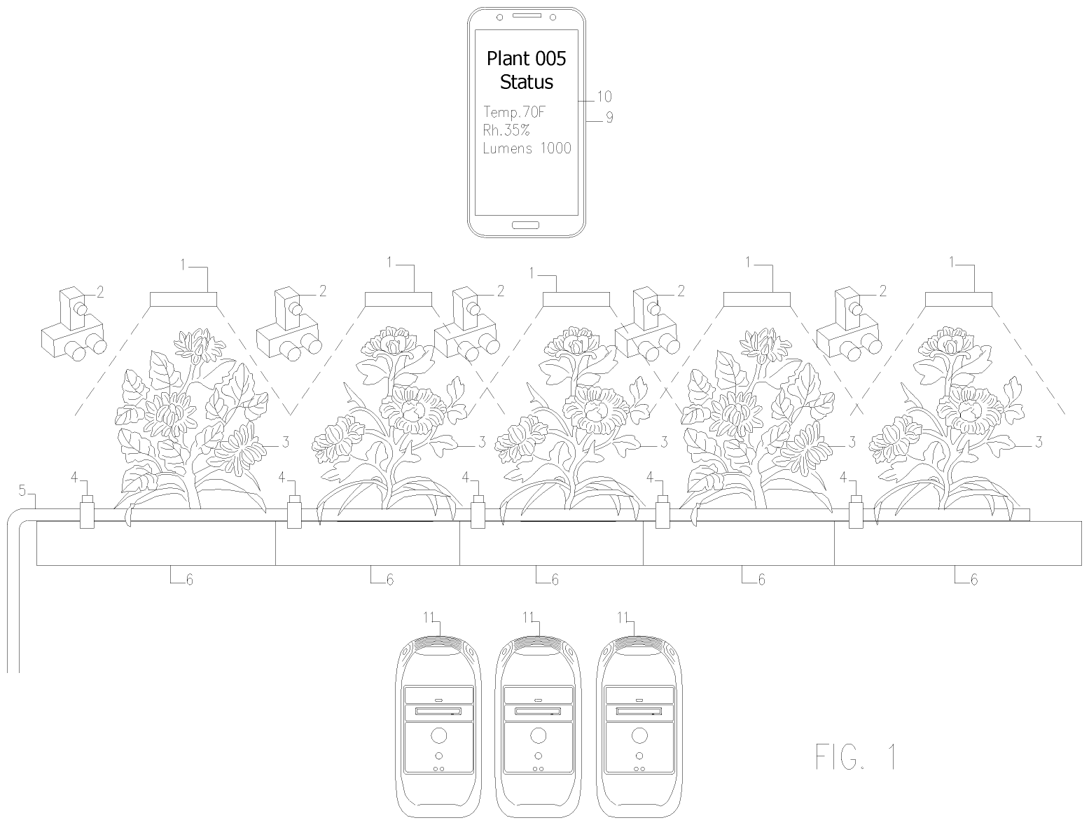

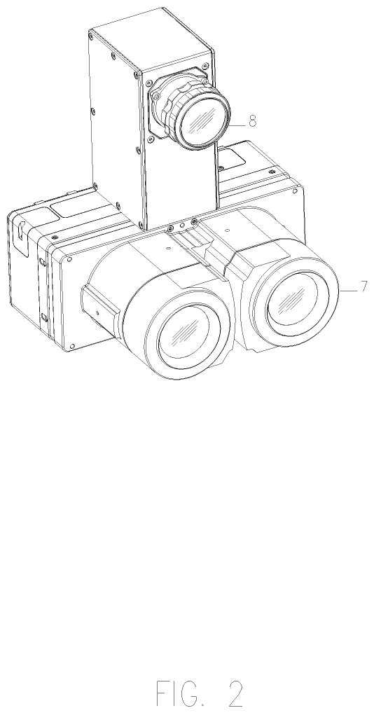

FIGS. 1 and 2 show perspective views of a preferred embodiment of the SPMS comprising the following parts: an external microprocessor 11 with internal memory, central processing unit, firmware and wireless communications; a multitude of LED grow lights 1 (positioned over each plant and independently controlled by said microprocessor) having a microcontroller with transmitter that sends and receives wireless commands from external microprocessor 11; a drip irrigation system with individual metering valves for each plant (also having microprocessors controlled by said external microprocessor 11); a plurality of sensor/camera units 7 and 8 that provide optical color recognition (for detecting leave discoloration) and sensors that include but are not limited to temperature, RH, CO2, motion and the like; and a mobile device app 9 that interacts wirelessly with a cloud network. All computing devices connect to said cloud network and can perform routine status reporting, data retrieval and device manual over-rides. The aforementioned camera 7 and sensor unit 8 having wireless transmitters and sending and receiving commands from external microprocessor 11 as well. Said irrigation system also being plumbed with individual lines with fluids that include but are not limited to fertilizers, herbicides, and insecticides with flows that are also controlled by individual flow meters for each plant by means of the external microprocessor 11.

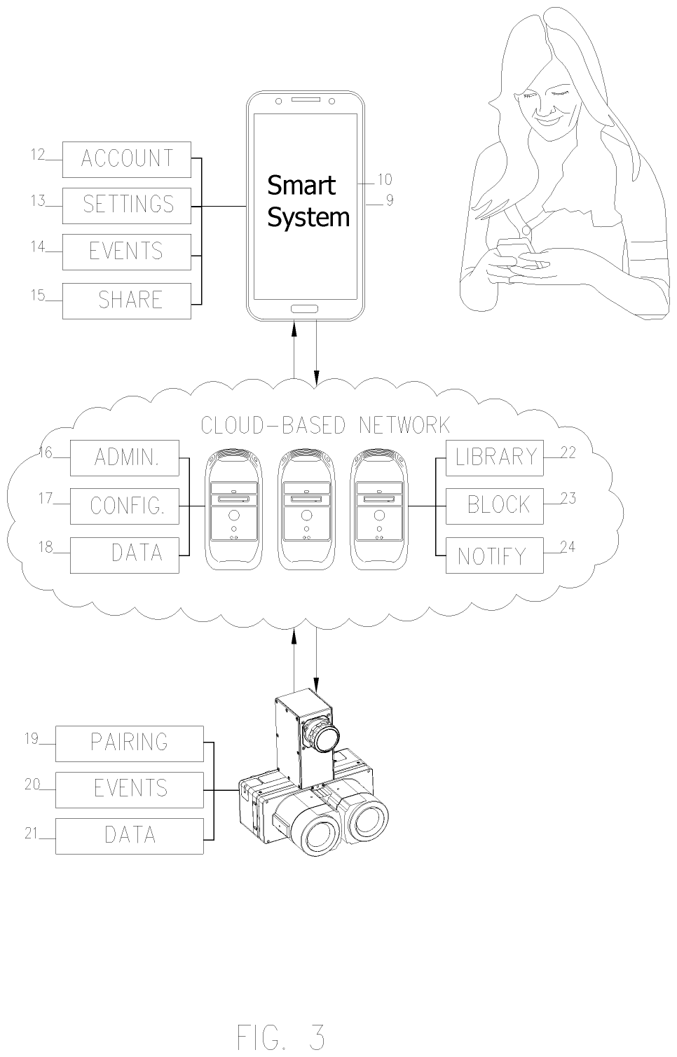

FIG. 3 showing a representative view of the SPMS operations that include but are not limited to the following: the user's app having account preferences 12 (subscriptions, demographics etc.); settings 13 (parameters such as water flows, temperatures, humidity levels, ventilation rates, insecticide levels, herbicide levels, and nutrient levels etc.); settings for recording and notifications for threshold event breaches 14; and sharing of all data via social media platforms 15 (SMS, text messages, email etc.). The camera/sensor units 7 and 8 having microprocessors with wireless transmitters for pairing and handshaking of data 19; threshold event breach recordings 20 (internal memory storage); and plant parameter data transmissions that are shared 21. Said app and camera/sensor units being connected by means of a cloud-based network with operations that include but are not limited to: administrative routines 16 (payments, user records etc.); configurations 17 (pairing plant devices and camera/sensor units etc.); data transmission 18 (wireless WiFi and Bluetooth connectivity between said app, camera/sensor units; and app etc.); independent plant library 22 with block chain tracking 23 and threshold breach notifications 24 associated with each plant (audible alarms, emails, SMS, text messages etc.).

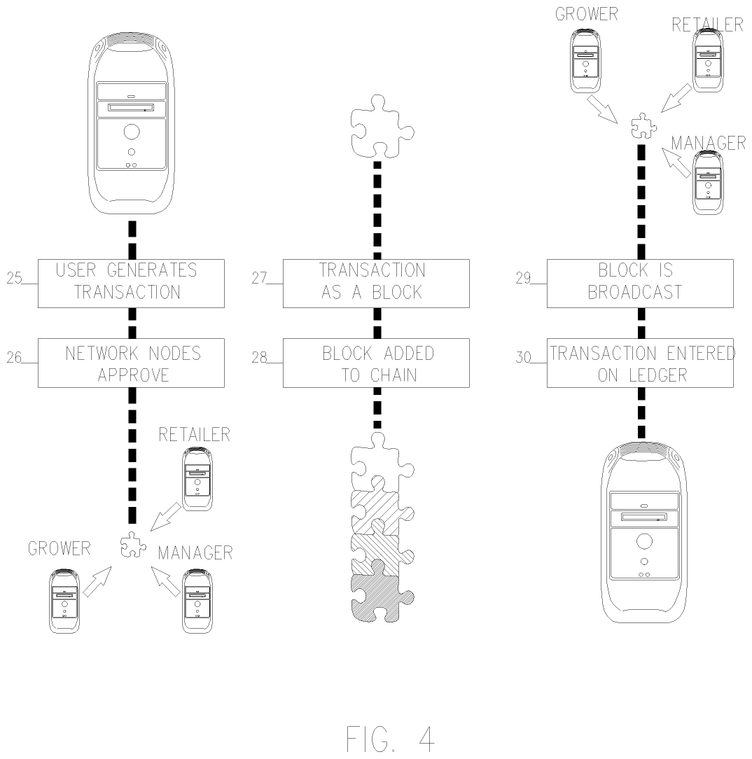

FIG. 4 showing the block chain aspect of the SPMS. Once recorded, the data in any given block cannot be altered retroactively, without alteration of all subsequent blocks, which requires consensus of the network majority. Combined with smart contracts, such blockchains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met-such as sharing records automatically with pre-approved parties using digital signatures. Each block in the software contains a cryptographic hash of the previous block, a timestamp, and transaction data. By design, a blockchain is resistant to modification of the data. For use as a distributed ledger, a blockchain is typically managed by a peer-to-peer network, collectively adhering to a protocol for inter-node communication and validating new blocks.

The block chain software in the SPMS in FIG. 4 recognizes the initial transaction and it is registered as a genesis block 25 after being approved by network nodes 26 made up of but not limited to: growers, retailers and managers and the like. When a user continues transactions 27 including registration, completing an exam etc., each transaction being is encrypted and added to the previous block 28 forming a hashed block chain wherein each transaction has a timestamp and metadata that is broadcast 29 to said authorized stakeholders as a recorded transaction 30 and being available only on the cloud network. By design, a block chain is resistant to modification of the data. For use as a distributed ledger, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met-such as sharing records automatically with pre-approved parties using digital signatures. FIG. 4 showing and embodiment of the notification process as growers, retailers and managers are notified of each plants status that are posted on a website on the cloud interface on smart phones and desktop computers etc.

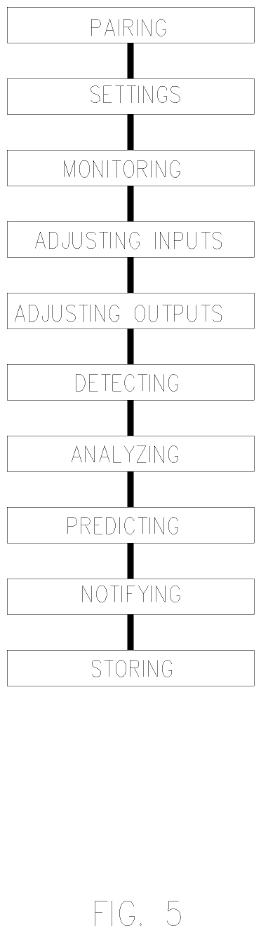

FIG. 5 showing a representative view of the SPMS method that includes but is not limited to the following steps: pairing all devices (cameras, LEDs, sensors, valves, etc.) with the external microprocessor, app and cloud network; providing threshold settings for all said devices (color limits, lighting levels, motion limits, CO2 levels etc.); monitoring plant conditions (leaf color, soil moisture content, CO2 levels, plant height etc.); adjusting inputs (water, herbicide, insecticide, fertilizer etc.); adjusting outputs (ventilation rates etc.); detecting invasives and pathogens (vermin, insects and fungal growth etc.); AI analysis of all plant parameters; AI predicting input needs and adjusting said inputs; notifying stakeholders of plant status and any problem plants; and storing all growth cycles data on the block chain per each individual plant.

In view of the disclosure provided herein, the app is created by techniques known to those of skill in the art using hardware, languages, and development environments known to the art. Those of skill in the art will recognize that mobile applications are written in several languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof. The software also compatible with a plurality of operating systems such as, but not limited to: Windows™, Apple™, and Android™, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK. [0019] Those of skill in the art will recognize that several commercial forums are available for distribution of mobile applications including, by way of non-limiting examples, Apple® App Store, Google® Play, Chrome Web Store, Black Berry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications. In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In some embodiments, the platforms, systems, media, and methods disclosed herein include software, server, and/or database modules, or use of the same. In view of the disclosure provided here in, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A system for managing plant health and growth autonomously comprising the following parts:
a) an external microprocessor for controlling all systems;
b) a multitude of LED grow lights to allow exposure for each individual plant;
c) a drip irrigation system for providing fluids to each individual plant;
d) block chain technology for tracking plant status and growth cycles;
e) a plurality of sensor and camera units;
f) a cloud network for interacting with all systems wirelessly; and
g) a mobile device app allowing for viewing plant status.

2. The system of claim 1, wherein the external microprocessor includes internal memory and wireless communications.

3. The system of claim 1, wherein the LED grow lights are controlled by said microprocessor.

4. The system of claim 1, wherein the drip irrigation system having individual metering valves for each plant controlled by said microprocessor Said irrigation system also being plumbed with individual lines that include but are not limited to fertilizers, herbicides, and insecticides with flows that are also controlled by individual flow meters for each plant.

5. The system of claim 1, wherein the plurality of sensor/camera units having optical color recognition for detecting leave discoloration, pairing and handshaking, threshold breach recordings, and plant parameter data transmissions capabilities.

6. The system of claim 1, wherein the plurality of sensor/camera also having temperature, RH, CO2 detection.

7. The system of claim 1, wherein the mobile device app having account preferences such as subscriptions, demographics etc.; settings such as parameters such as water flows, temperatures, humidity levels, ventilation rates, insecticide levels, herbicide levels, and nutrient levels.

8. The system of claim 1, wherein the cloud-based network with operations that include administrative routines such as payments, user records etc.; configurations such as pairing plant devices and camera and sensor units etc.; data transmission such as wireless WiFi and Bluetooth connectivity between said app, camera and sensor units; and app etc.; independent plant library with block chain tracking and threshold breach notifications associated with each plant such as audible alarms, emails, SMS, text messages.

9. A method for managing plant health and growth autonomously comprising the following steps:
a) providing the system of claim 1;
b) pairing all devices with the external microprocessor, app and cloud network;
c) providing threshold settings for all said devices;
d) monitoring plant conditions;
e) adjusting inputs;
f) adjusting outputs;
g) detecting invasives and pathogens;
h) analyzing all plant parameters with artificial intelligence;
i) predicting input needs and adjusting said inputs with artificial intelligence;
j) notifying stakeholders of plant status and any problem plants; and
k) storing all data on the block chain per each individual plant.

10. The method of claim 9, wherein the pairing includes the step of pairing cameras, LEDs, sensors, and valves with the external microprocessor, app and cloud network.

11. providing threshold settings for all said devices that includes the step of setting color limits, lighting levels, motion limits, CO2 levels.

12. The method of claim 9, wherein the threshold settings includes the step of setting color limits, lighting levels, motion limits, and CO2 levels.

13. The method of claim 9, wherein the monitoring plant conditions includes the step of monitoring leaf color, soil moisture content, CO2 levels, plant height.

14. The method of claim 9, wherein the adjusting inputs includes the step of adjusting water, herbicide, insecticide, fertilizer.

15. The method of claim 9, wherein the adjusting outputs the step of adjusting ventilation rates.

16. The method of claim 9, wherein the detecting invasives and pathogens includes the step of detecting vermin, insects and fungal growth.
